(19) United States
(12) Patent Application Publication
(10) Pub. No.: US 2003/0055725 A1
(43) Pub. Date: Mar. 20, 2003

(54) Advertisement providing system by using a wireless internet and method thereof

(76) Inventor: Jaewon Lee, Seoul (KR)

Correspondence Address: LADAS & PARRY, 26 WEST 61ST STREET, NEW YORK, NY, 10023, US

(21) Appl. No.: 10/221,057

(22) PCT Filed: Mar. 7, 2001
(86) PCT No.: PCT/KR01/00344

(30) Foreign Application Priority Data
Mar. 21, 2000 (KR) 2000/14171

(51) Int. Cl. G06F 17/60

(52) U.S. Cl. 705/14

(57) ABSTRACT

The present invention relates to system and method for providing advertisements administered by advertisers in use of the wireless internet, which allows advertisers to directly input advertisements by accessing a web server through the internet or wireless internet, a web server to automatically build one or more inputted advertisements as advertisement contents, and the built advertisement contents to be provided in response to the advertisement viewing requests of wireless internet users.

### TECHNICAL FIELD

The present invention relates to system and method for providing advertisements in use of wireless internet, and more particularly to system and method for providing advertisements administered by advertisers in use of the wireless internet, which allows advertisers to directly input advertisements by accessing to a web server through the internet or wireless internet, a web server to automatically build one or more inputted advertisements as advertisement contents, and the built advertisement contents to be provided in response to the requests of mobile terminals such as mobile phones, PDA, and the like, which wireless internet users use to view the advertisements.

### BACKGROUND ART

In general, a conventional advertisement method using an information communication network allocates certain regions of web site homepages for banners or box shapes and displays advertisements to specific goods or services in the regions. Thereafter, if a visitor of the homepages clicks on the banner or box advertisements, a link is made to display advertisement contents which introduce goods and services of the corresponding advertisements, so the visitor can get information on the form and contents of goods, inclusive of services, of the advertising company.

Lots of applications for patent relating to advertisements using the internet have been made, and, in particular, Korean Patent Application No. 10-1998-04100 discloses an advertisement method for enhancing the efficiency of an advertisement effect by providing a user with an image in which advertisement information is hidden and, if the user finds out the advertisement information hidden in the image, compensating the user for it.

Further, Korean Patent Application No. 10-1996-076719 relates to customized advertisements which allows a user to view only the advertisements he or she wants, Korean Patent Application No. 10-1996-0399834 prepares the advertisements users want to be fit for the users and provides the advertisements fit for the users by distinguishing the users' characteristics, with the advertiser's payments for internet use fees, and Korean Patent Application No. 10-1997-010798 discloses a method for displaying advertisements on internet main menus, decoding advertisement storage positions.

In the meantime, developments of advertisement methods through the wireless internet have been requested with the use of the wireless internet activated in recent, and the banner advertisements widely prevailed in the internet are not activated to the advertisement market in the wireless internet with technological difficulty in use.

Further, another different advertisement method in use of mobile phones rather than the wireless internet is to transfer character messages including advertisement phrases and the like on the mobile phones by inputting the character messages including advertisement phrases and the like and mobile phone numbers in an internet site, and there is an advertisement method through electronic mails. However, such advertisement methods are not services through web browsers of the wireless internet.

In the meantime, in a conventional internet advertisement method, site administers directly operate the posting, correcting, and deleting jobs for internet site advertisements. At this time, advertisers has the inconvenience that they have to send advertisement-related materials to advertisement media administers through telephones, faxes, and electronic mails all the time.

The problem results from the methods passively operated in the internet advertisements at present and not allowing advertisers to administer the advertisement inputs, and the reason of which is because the input process of advertisements can not be automatically implemented.

### DISCLOSURE OF THE INVENTION

Accordingly, the present invention has been advised to solve the above problem, so it is an object of the present invention to provide system and method for providing advertisements administered by advertisers in use of the wireless internet, which allows advertisers to directly input advertisements by accessing to a web server through the internet or wireless internet, a web server to automatically build one or more advertisements inputted as advertisement contents, and the built advertisement contents to be provided in response to the demands for wireless internet users to view the advertisements.

In order to achieve the above object, the present invention comprises an advertisement input unit for, if an advertiser connects through internet or wireless internet communication network and requests an advertisement application, transferring an advertisement application screen to the advertiser and receiving advertisement information from the advertiser; a database for storing the advertisement information classified by type for computerization, wherein the advertisement information is received from the advertiser to the advertisement input unit; a document conversion unit for reading in an advertisement list from the database in response to the advertisement transfer request, converting the advertisement list into a format fit for a wireless internet markup language of a mobile communication terminal of requesting the advertisement transfer for an output, in response to the request of the advertisement information to the advertisement selected from the advertisement list, reading in the corresponding advertisement information from the database and converting for an output the advertisement information into a format fit for a markup language of the mobile communication terminal of requesting the advertisement transfer; and an advertisement list-producing unit for receiving an advertisement transfer request from the mobile communication terminal user through the mobile communication terminal, reading in and providing an advertisement list from the database through the document conversion unit, and, if the mobile communication terminal user selects a desired advertisement from the advertisement list and requests an advertisement information transfer, reading in and providing an advertisement list from the database through the document conversion unit.

Further, a method according to the present invention, in an advertisement-providing system having an advertisement input unit for, if an advertiser connects through internet or wireless internet communication network and requests an advertisement application, transferring an advertisement application screen to the advertiser and receiving advertisement information from the advertiser; a database for storing the advertisement information classified by type for computerization, wherein the advertisement information is received from the advertiser to the advertisement input unit; a document conversion unit for reading in an advertisement list from the database in response to the advertisement transfer request, converting the advertisement list into a format fit for a wireless internet markup language of a mobile communication terminal of requesting the advertisement transfer for an output, in response to the request of the advertisement information to the advertisement selected from the advertisement list, reading in the corresponding advertisement information from the database and converting for an output the advertisement information into a is format fit for a markup language of the mobile communication terminal of requesting the advertisement transfer; and an advertisement list-producing unit for receiving an advertisement transfer request from the mobile communication terminal user through the mobile communication terminal, reading in and providing an advertisement list from the database through the document conversion unit, and, if the mobile communication terminal user selects a desired advertisement from the advertisement list and requests an advertisement information transfer, reading in and providing an advertisement list from the database through the document conversion unit, comprises steps of (S1) collecting advertisement information from the advertiser and storing the database by using the advertisement input unit; (S2) storing the advertisement information in the database, extracting related information from the database by the request of the advertisement list-producing unit, and converting the extracted information into a markup language document fit for a wireless internet protocol of the mobile communication terminal; and (S3) reading in, if the mobile communication terminal user requests an advertisement transfer through connections, the advertisement information from the database, converting and transferring the read information into a markup language fit for the mobile communication terminal.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for showing a system for providing advertisements according to an embodiment of the present invention;

FIG. 2 is an internal block structure of a service-providing server of FIG. 1;

FIG. 3 is a flow chart for explaining a method for providing advertisements in the system of FIG. 1; and

FIG. 4a and 4b are flow charts for showing in detail steps for collecting advertisements in FIG. 3.

FIG. 5 is a flow chart for showing in detail the advertisement retrieving step of FIG. 3.

### BEST MODE FOR CARRYING OUT THE INVENTION

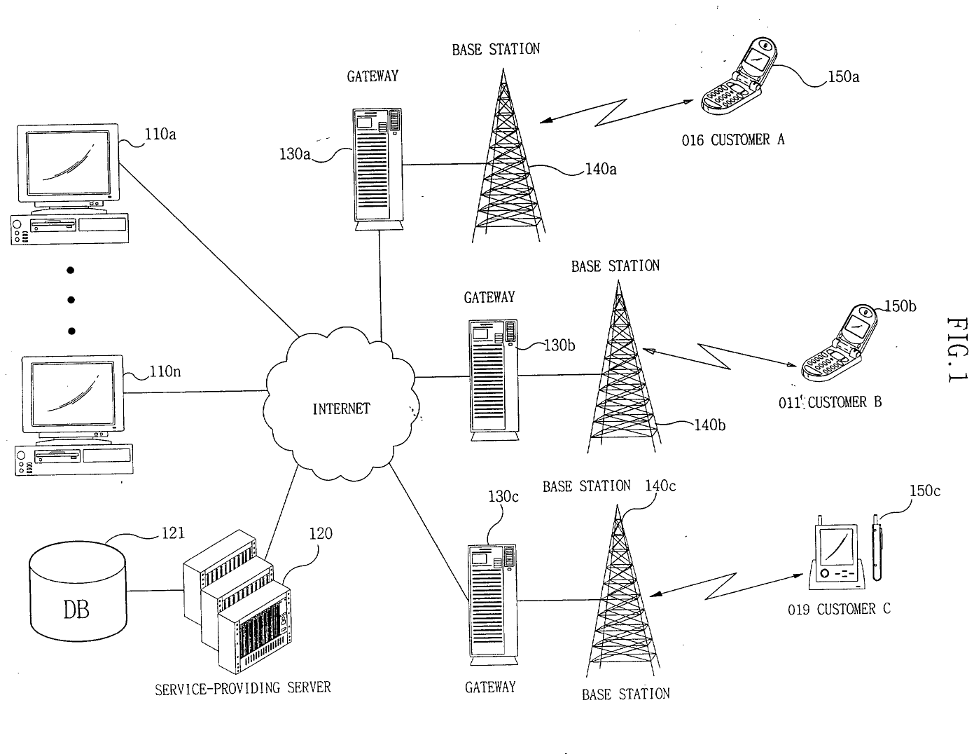

Hereinafter, a preferred embodiment of the present invention will be described in detail with reference to the accompanying drawings starting with FIG. 1.

FIG. 1 is a view for showing a system for providing advertisements according to an embodiment of the present invention.

As shown in FIG. 1, the advertisement-providing system according to an embodiment of the present invention includes plural user terminals 110a to 110n, service-providing servers 120, a database 121, gateways 130a, 130b, and 130c, base stations 140a, 140b, and 140c, and mobile communication terminals 150a, 150b, and 150c.

The service-providing server 120 provides a web page having a log-in window for a log-in if an advertiser connects to the server 120 by using a user terminal 110a to 110n. In case that the advertiser is not a member, the server 120 provides a member registration window for the advertiser to be registered as a member.

Further, if the advertiser logs in, the server 120 provides a web page having an advertisement application button which is linked to an advertisement application web page, and, if the advertiser clicks on the advertisement application button, provides the advertisement application web page. At this time, the advertisement application web page provides various samples of advertisement-manufacturing styles, and allows the advertiser to select a sample he or she wants from the provided samples. The server 120 allows the advertiser to select and input advertisement types such as job opportunities/job wanted, recruitments, announcements, and so on, and an advertisement posting date or an advertisement posting period of time, together with advertisement contents. Further, if the advertiser wants advertisements with graphics, audios, or videos, the server 120 allows the advertiser to transfer the advertisement contents together with graphic, audio, or video files.

The service-providing server 120 which has received the advertisement information stores the advertisement information in the database 121, and, at this time, grasps the advertisement type, and databases the advertisement information in a suitable position based on the grasped advertisement type.

In the meantime, although an explanations are made about the step through which the advertiser automatically inputs the advertisement contents, in case that advertisement materials have been already posted on an internet homepage or an wireless internet homepage, the service-providing server 120 may be realized to monitor the posted advertisements promised beforehand, acquire homepage materials including the advertisements, and extract only the advertisement materials required.

That is, the service-providing server 120, if the advertisements promised beforehand are posted, monitors the advertisements, brings in homepages including the advertisements, and recognizes and extracts only advertisement materials from the brought materials with reference to the characteristics of the advertisements promised in advance with the advertiser. At this time, for the service-providing server 120 used for realizing such technology, an intelligent web server(or an intelligent agent, or a soft agent) using artificial intelligent technologies may be used.

Next, the service-providing server 120, if a user connects to it by using mobile communication terminals 150a, 150b, and 150c, provides listed advertisement types to the advertisements, and, if the user selects a desired advertisement type from the provided advertisement list, provides a list of advertisements according to the selected advertisement type.

Further, if the user selects a desired advertisement from the offered advertisement list, the service-providing server 120 reads in the selected advertisement information from the database 121 and provides it to the mobile communication terminals 150a, 150b, and 150c.

At this time, the service-providing server 120 is required to convert data into document types fit for the mobile communication terminals 150a, 150b, 150c to provide the advertisement information.

That is, for users who use mobile communication terminals having numbers of 011 or 017, the document types need to be converted into the WML markup language format for providing, for users who use mobile communication terminals having numbers of 016 or 018, the document types need to be converted into the mHTML markup language format for providing, and, for users who use mobile communication terminals having a number of 019, the document types need to be converted into the HTML markup language format for providing. Such conversions are automatically carried out through a document conversion unit equipped in the service-providing server 120.

In the meantime, even though a description has been made about applying for advertisements through the internet here, it may be realized that the same advertisements can be applied through the wireless internet, that is, by using the mobile communication terminals 150a, 150b, and 150c.

Further, it may be realized that advertisers can input, delete, and correct the advertisements of their own applying.

For sure, as mobile communication terminals available for the wireless internet, personal digital assistants(PDAs), smart phones, IMT-2000 phones, and the like may be used in addition to the mobile phones.

Furthermore, a method for attracting mobile communication terminal users to connect to wireless internet homepages is to briefly notify of event information by using the short message service(SMS) to visit the wireless internet homepages for detailed contents. That is, if an advertiser connects to the service-providing server 120 and requests an advertisement application, the service-providing server 120 provides an advertisement application web pages including a short message input window.

Accordingly, the advertiser inputs some statements of notifying of event information and announcement messages that detailed contents can be viewed when visiting the wireless internet homepage in the short message input window of the advertisement application web page provided, inputs and sends plural mobile communication terminal numbers to which the short messages are transferred, as well as advertisements. Accordingly, the service-providing server 120 receives the advertisement application web pages and stores the inputted advertisements in the database 121, transfers the short messages to respective mobile communication terminals of the plural mobile communication terminal numbers such as 011, 017, and so on, so that mobile communication terminal users view the short messages, connect to the service-providing server 120, and view the advertisements.

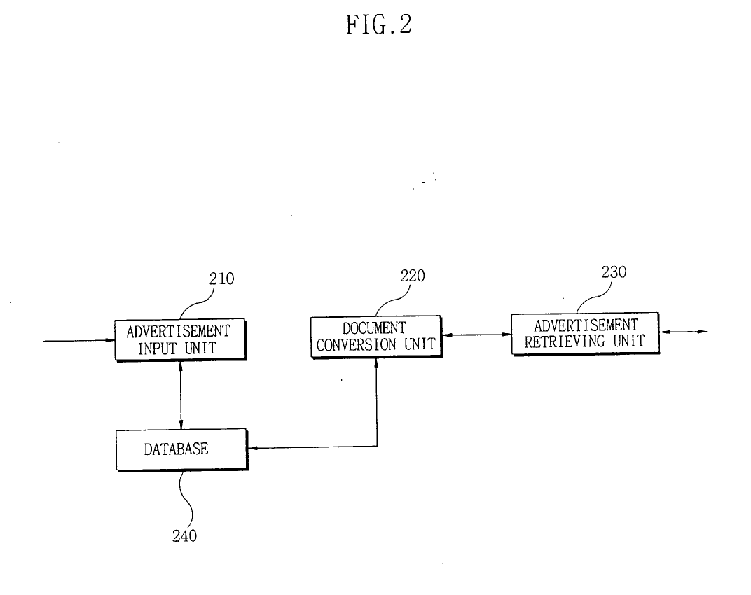

FIG. 2 is a view for showing an internal block structure of the service-providing server of FIG. 1.

As shown in FIG. 2, the service-providing server includes an advertisement input unit 210, a document conversion unit 220, and an advertisement retrieving unit 230.

Here, the advertisement input unit 210, if an advertiser connects through the communication network, provides the advertisement application web pages, and, as the advertiser inputs and transfers advertisement information in the provided advertisement application web pages, stores the transferred advertisement information in the database 240. Further, the advertisement input unit 210 has an intelligent function, so that, in case that materials for advertisements has been posted on arbitrary internet homepages or wireless internet homepages and if the advertisement promised beforehand is posted, it monitors the advertisements, takes in the materials of the homepages including the advertisements, recognizes and extracts only the advertisement materials from the taken materials in the database 240 with reference to the characteristics of the advertisements promised with the advertiser beforehand.

Next, if a mobile communication terminal user connects to the service-providing server by using his mobile communication terminal, the advertisement retrieving unit 230 of the service-providing server provides an advertisement list classified by advertisement type.

For an example of the advertisement list, the first step has classified advertisement categories classified into restaurants, household products, vehicles, computers, and so on, the second step for western, Korean, Japanese foods, and so on, and the third step for areas such as Jongro-Ku, Jung-Ku, Yangcheon-Ku, and so on, and, if Jongro-Ku is selected, the next step shows a list of restaurant names.

At this time, the selection control of an advertisement list is made for a desired advertisement list by using a scroll bar, a selection key, or the like, and moving the advertisement lists, while a mobile communication terminal user views an output screen of his mobile communication terminal. After transferred to the advertisement retrieving unit 230, a sub-list of the selected advertisement list is transferred to the mobile communication terminal.

Further, if a mobile communication terminal user requests a transfer of advertisement information itself to the advertisement retrieving unit 230 by selecting an advertisement desired in the last sub-list provided, the advertisement retrieving unit 230 requires a transfer of the selected advertisement information to the document conversion unit 220.

The document conversion unit 220 which requests the advertisement transfer reads in from the database 240 advertisement materials corresponding to the selected advertisement list item, converts it into a markup language format the mobile communication terminal uses for providing.

That is, conversions are made into the WML markup language for mobile communication terminal users in 011 and 017 number services, into the mHTML markup language for mobile communication terminal users in 016 and 018 number services, and into the HDML markup language for mobile communication users in 019 number service, for providing the advertisement information.

In the meantime, although it is realized for advertisements to be applied for through the internet in the above, it may be realized for advertisements to be applied for by using the wireless internet.

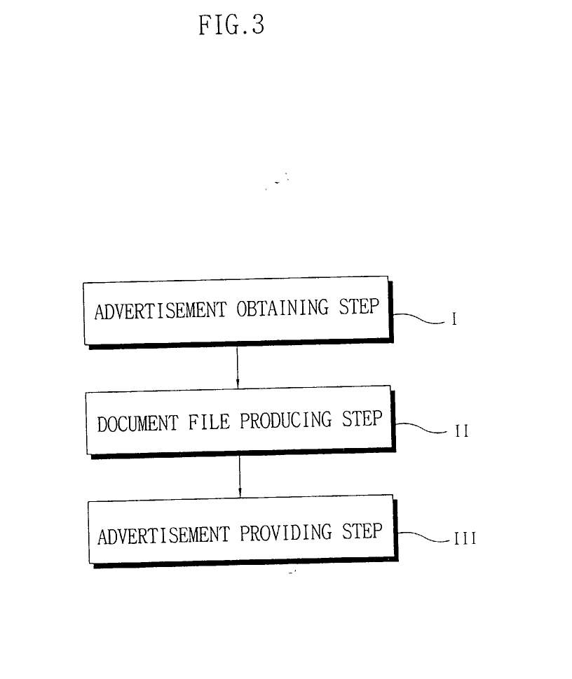

FIG. 3 is a flow chart for explaining a method for providing advertisements in the system of FIG. 1.

As shown in FIG. 1, a step I is for collecting advertisements, and methods for collecting advertisements are mainly classified into a first method for collecting advertisements, wherein a service-providing server automatically makes access to internet homepages or wireless internet homepages to bring in related homepage files from which advertisement materials are extracted, and a second method for collecting advertisements, wherein a service-providing server receives advertisement materials from an advertiser as the advertiser applies for advertisements by connecting to the service-providing server through a communication network.

Further, a step for collecting advertisement materials is described in detail as follows. In the first method, an advertisement input unit of the service-providing server(an intelligent web server), if advertisement-related materials are posted on internet homepages or wireless internet homepages, monitors related homepages in a regular or irregular basis, fetches related homepage files on the internet homepages or wireless internet homepages, extracts only advertisement materials from the related homepage files fetched, and stores the extracted materials, to thereby enable the advertisement materials to be collected.

Next, in the second method, if an advertiser logs in by connecting to a service-providing server through the internet, or wireless internet, and so on, the advertisement input unit provides advertisement application web pages to input advertisement information and, as the advertiser transfers the advertisement application web pages in which the advertisement information is inputted, receives the advertisement information, classifies the advertisement information by advertisement type, and stores the classified advertisement in a database.

A second step is for producing document files. The document-producing step, if a wireless internet user requires an advertisement transfer, grasps the characteristics of a wireless internet user, and produces and outputs document files fit for the characteristics. That is, since documents prepared in a protocol fit for the type of a mobile communication terminal connected at present should be transferred, conversion for transferring is required into the WML markup language format for the mobile communication terminals of 011 and 017 number services, into the mHTML markup language format for the mobile communication terminals of 016 and 018 number services, and into the HTML markup language format for the mobile communication terminals of 019 number service.

A third step is for providing advertisement lists. If a customer who uses mobile communication terminals 150a, 150b, and 150c are to request viewing advertisement contents, the customer connects to a wireless internet site by using a web browser of his/her mobile communication terminal and inputting the URL of the wireless internet site from which the viewing of advertisements is available. At this time, the advertisement retrieving unit 230 detects a user's connection try, identifies a wireless internet markup language, for example, WML, mHTML, HTML, and so on, of a mobile communication company, and requests necessary advertisement lists to the document conversion unit. The advertisement lists provided by the document conversion unit are transferred to the mobile communication terminal, and, if an advertisement item is selected from these lists, the communications between the advertisement list-producing unit and the terminal after the selection proceed until the final step of the list, having the same cycle as the initial connection trial.

If a particular item is chosen from the advertisement list of the final step, advertisement contents of the corresponding item transferred from the document conversion unit are finally sent to the mobile communication terminal accordingly. The end of the providing of the advertisement list is made after viewing the advertisements or when finishing the execution of a web browser of the terminal at any time during viewing the advertisements, together with the end of the viewing.

If a wireless internet user requests a transfer of advertisements he or she wants from an advertisement list provided through connections, advertisement information is transferred by using the wireless internet.

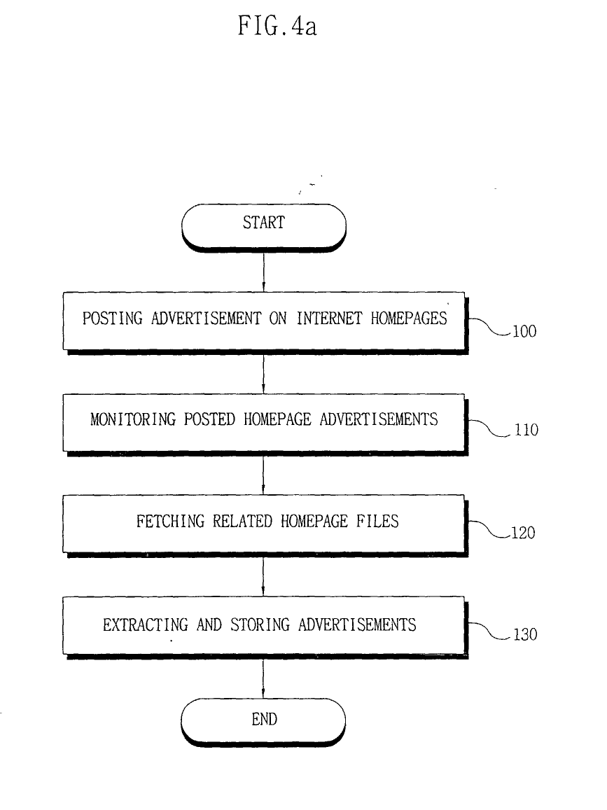

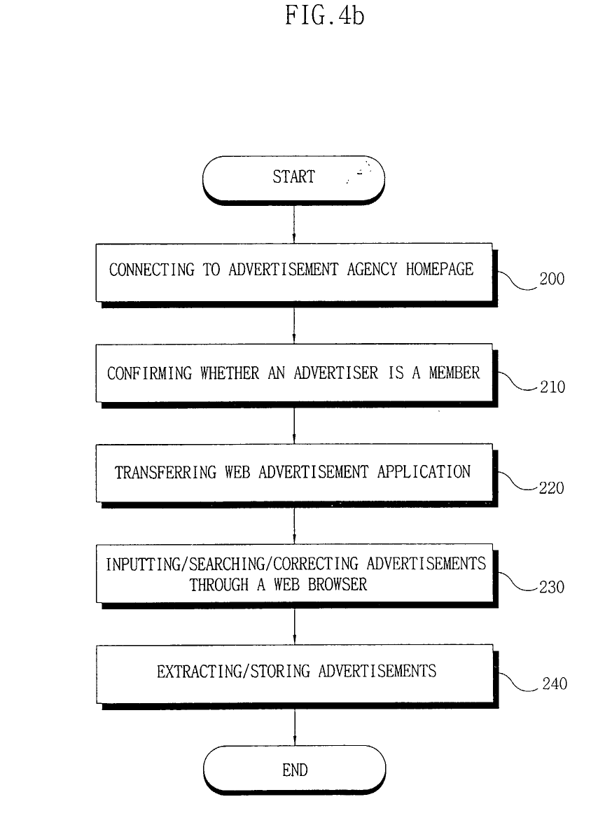

FIG. 4a and FIG. 4b are flow charts for showing in detail steps for collecting advertisements in FIG. 3.

In the drawings, FIG. 4a is a flow chart for showing steps for collecting advertisements posted on internet homepages or wireless internet homepages. First, if related advertisements are posted on homepages in step 100, step 110 monitors and identifies the related homepages in a certain period of time.

Thereafter, step 120 fetches related homepage files from the internet homepages or the wireless internet homepages. Step 130 extracts advertisement materials from the related homepage files and stores the extracted advertisement materials in a database.

In the drawings, FIG. 4b is a flow chart for explaining a method for providing advertisements in case that an advertiser himself directly inputs the advertisements through a web browser. First, if an advertiser connects to a service-providing server, step 210 identifies whether the advertiser is a member, and step 220 transfers an advertisement application web page required for advertisement inputs to a web browser of the advertiser.

In step 230, the advertiser inputs data necessary for inputs, searches, and corrections of the advertisements by using the transferred advertisement application web page. Step 240 extracts advertisements and stores the extracted advertisements in the database.

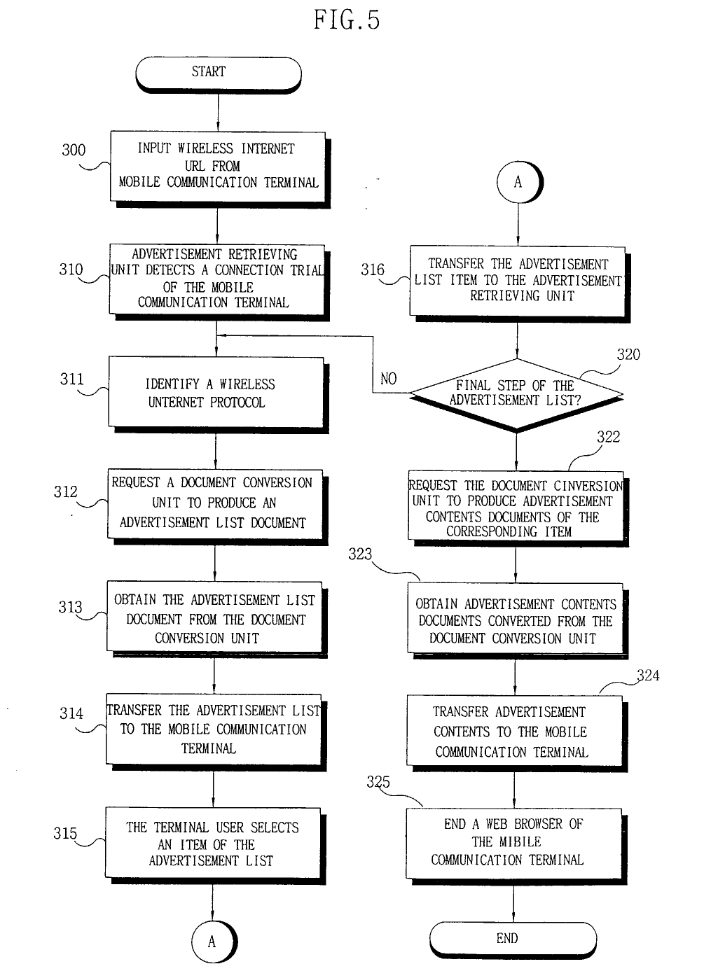

FIG. 5 is a flow chart for showing in detail the advertisement retrieving step of FIG. 3.

As shown in FIG. 5, in order for a mobile communication terminal user to request the viewing of advertisement contents, the user inputs an URL of a wireless internet site available for the viewing of advertisements and connects to the wireless internet site by using a web browser of his mobile communication terminal(Step 300).

At this time, the advertisement retrieving unit detects a user's connection trial(Step 310), identifies a wireless internet markup language such as WML, Mhtml, HDML, or the like of a mobile communication company(Step 311), and requests a necessary advertisement list to the document conversion unit(Step 312).

The advertisement list provided by the document conversion unit is transferred to the mobile communication terminal(Steps 313 and 314), and, if an advertisement item is selected from the advertisement list(Step 315), the communications between the advertisement list-producing unit and the terminal after the selection proceed until the final step of the list, having the same cycle as the initial connection trial(Step 320).

If a particular item is chosen from the advertisement list of the final step, the advertisement retrieving unit requests the document conversion unit to produce advertisement contents documents to the corresponding item(Step 322), obtains the converted advertisement contents documents from the document conversion unit(Step 323), and transfers the obtained advertisement contents documents to the mobile communication terminal(Step 324). The end of the providing of the advertisement list is made after viewing the advertisements or when finishing the execution of a web browser of the terminal at any time during viewing the advertisements, together with the end of the viewing(Step 325).

According to the present invention as stated above, in advertisement environments that advertisements are valid for a certain period of time as in an event performance and frequently changed in their contents, since an advertiser can directly post and change advertisements if he or she is authorized in use without cooperation requests in advance in detail, it has an effect that collections and drives for dynamic advertisement strategies can be easily carried out. Further, according to the present invention, since an advertisement user can receive rapid services, more advantages may be obtained than internet advertisements.

Further, the present invention, since direct inputs of advertisements through the wireless internet such as mobile communication terminals, provides convenience in that an advertiser can post his advertisements in circumstances he or she can not use a personal computer.

Further, the present invention can overcome the limitations of advertisements through existing flyers, newspaper, or other mass media with difficulties in advertisement confirmations if not noted or scrapped, since the advertisement confirmations can be made on the wireless internet. In particular, the excellence in mobility in case of the wireless internet makes the advertisement use easily available at any time and at any place in an area where the mobile phones are applicable for communications.

Further, the present invention can expand internet and wireless internet advertisement markets with the handiness in advertisement inputs for an advertiser and the mobility in advertisement use through the wireless internet, In particular, it is expected that the present invention steps up the internet marketing to the wireless internet marketing.

Further, the present invention can conveniently provide advertisement information even at any time, any place, any narrow space, and so on, due to portability and mobility of mobile communication terminals, allowing customer relationship managements through advertisements of a new dimension which may be hardly achieved with the existing advertisement delivery media.

What is claimed is:

1. A system for providing advertisements, comprising:
an advertisement input unit for, if an advertiser connects through a communication network and requests an advertisement application, transferring an advertisement application screen to the advertiser and receiving advertisement information from the advertiser;
a database for storing the advertisement information classified by type for computerization, wherein the advertisement information is received from the advertiser to the advertisement input unit;
a document conversion unit for reading in an advertisement list from the database in response to the advertisement transfer request, converting the advertisement list into a format fit for a wireless internet markup language of a mobile communication terminal of requesting the advertisement transfer for an output and producing a list document, in transferring to the terminal advertisement information corresponding to an advertisement item of a final step of the advertisement list which is selected by the user from the advertisement list transferred to the terminal, reading in the advertisement information from the database like the advertisement list and converting for an output the advertisement information into a format fit for a wireless internet markup language of the mobile communication terminal of requesting the advertisement transfer;
and an advertisement retrieving unit for receiving an advertisement transfer request from the mobile communication terminal user through the mobile communication terminal, reading in and providing an advertisement list from the database through the document conversion unit, and, if the mobile communication terminal user selects an advertisement list item of a final step through step-by-step selections in the advertisement list and requests an advertisement information transfer corresponding to the selected item, reading in and providing an advertisement list from the database through the document conversion unit.

2. The system as claimed in claim 1, wherein the advertisement input unit, in case that advertisement-related materials of the advertiser are posted on internet homepages or wireless internet homepages, monitors related homepages in a regular or irregular basis, fetches related homepage files, extracts only advertisement materials from the fetched homepage materials, and stores the extracted materials in the database.

3. The system as claimed in claim 1 or claim 2, wherein the advertisement input unit inputs advertisement information by using a client unit from the advertiser who connects through an internet network.

4. The system as claimed in claim 1 or claim 2, wherein the advertisement input unit inputs the advertisement information by using the mobile communication terminals from the advertiser who connects through the wireless internet network.

5. The system as claimed in claim 3, wherein the advertisement input unit provides to the advertiser an advertisement application web page including short message input window, and, if the advertiser inputs and transfers advertisement-related short messages, plural mobile communication terminal numbers, and advertisement contents, the advertisement-related short messages are transferred to mobile communication terminals corresponding to the mobile communication terminal numbers, and the advertisement input unit stores the transferred advertisement contents in the database.

6. The system as claimed in claim 1, wherein the advertisement information the advertisement input unit receives from the advertiser includes at least one or more from characters, graphics, audios, and video.

7. The system as claimed in claim 1, wherein the document conversion unit, according to identifiers of the mobile communication terminals, converts the advertisement list or the advertisement contents into a WML markup language format for the mobile communication terminal users having 011 and 017 identifiers, into an mHTML markup language format for the mobile communication terminal users having 016 and 018 identifiers, and into a HDML markup language format for the mobile communication terminal users having a 019 identifier.

8. A method for operating an advertisement-providing system having an advertisement input unit for, if an advertiser connects through a communication network and requests an advertisement application, transferring an advertisement application screen to the advertiser and receiving advertisement information from the advertiser; a database for storing the advertisement information classified by type for computerization, wherein the advertisement information is received from the advertiser to the advertisement input unit; a document conversion unit for reading in an advertisement list from the database in response to the advertisement transfer request, converting the advertisement list into a format fit for a wireless internet markup language of a mobile communication terminal of requesting the advertisement transfer for an output, and, in response to the request of the advertisement information transfer corresponding the an advertisement item selected from the advertisement list, reading in the advertisement information from the database and converting for an output the advertisement information into a format fit for a wireless internet markup language of the mobile communication terminal of requesting the advertisement transfer; and an advertisement retrieving unit for receiving an advertisement transfer request from the mobile communication terminal user through the mobile communication terminal, reading in and providing an advertisement list from the database through the document conversion unit, and, if the mobile communication terminal user requests a transfer of advertisement information corresponding to an advertisement item selected in a final step of the advertisement list, reading in and providing the advertisement information from the database through the document conversion unit, comprising steps of:
(S1) collecting the advertisement information from the advertiser by using the advertisement input unit;
(S2) storing the advertisement information collected in the step S1 in the database; and
(S3) reading in the advertisement information from the database and converting the advertisement information into a markup language fit for the mobile communication terminal for transferring.

9. The method as claimed in claim 8, wherein the step S1 includes steps of:
(S1-1) monitoring and identifying, if related advertisements are posted on homepages, the related homepages in a regular or irregular basis; and
(S1-2) fetching related homepage files from internet homepages or wireless internet homepages and extracting advertisement materials from the related homepage files.

10. The method as claimed in claim 8, wherein the step S1 includes steps of:
(S2-1) confirming whether the advertiser is a member if the advertiser connects to a service-providing server;
(S2-2) transferring an advertisement application web page necessary for inputting advertisements to an web browser of the advertiser; and
(S2-3) receiving the advertisement information from the advertiser.

11. The method as claimed in claim 8, wherein the step S3 includes steps of:
(S3-1) inputting for a connection an URL of a wireless internet site available for the viewing of advertisements by using a web browser by the mobile communication terminal user;
(S3-2) detecting a user's connection trial, identifying a wireless internet markup language format of a mobile communication company, and requesting a necessary advertisement list to the document conversion unit by the advertisement list-producing unit;
(S3-3) transferring to the mobile communication terminal the advertisement list provided by the document conversion unit, and, if an advertisement item is selected from the list, proceeding until a final step of the list by repeating the same steps as in an initial connection trial over the communications of the mobile communication terminal after the selection;
(S3-4) requesting the document conversion unit to produce advertisement contents documents of the corresponding item if a particular item is selected from the advertisement list of the final step, and obtaining the advertisement contents documents converted from the document conversion unit; and
(S3-5) transferring the obtained advertisement contents documents to the mobile communication terminal to view the advertisements.
